(19) United States
(12) Patent Application Publication
(10) Pub. No.: US 2026/0281761 A1
(43) Pub. Date: Sep. 17, 2026

(54) ARTIFICIAL INTELLIGENCE (AI)/MACHINE LEARNING (ML) MODEL DRIFT DETECTION METHOD BASED ON CONDITIONAL STATISTICAL METRIC

(71) Applicant: Telefonaktiebolaget LM Ericsson (publ), Stockholm (SE)

(72) Inventors: Zhan ZHANG, Beijing (CN); Yufei BLANKENSHIP, Kildeer, IL (US)

(21) Appl. No.: 19/471,800

(22) PCT Filed: Apr. 8, 2024
(86) PCT No.: PCT/SE2024/050331

§ 371 Date: Oct. 2, 2025

Related U.S. Application Data
(60) Provisional application No. 63/494,814, filed on Apr. 7, 2023.

(51) Int. Cl. H04W 24/08

(52) U.S. Cl. CPC H04W 24/08

(57) ABSTRACT

A method, system and apparatus are disclosed. A user equipment (UE) is configured to determine a first model monitoring metric for a first machine learning, ML, model, the first model monitoring metric being based on a statistical distance between a reference dataset and an operational dataset. The UE is configured to perform at least one action based on the first model monitoring metric.

### TECHNICAL FIELD

The present disclosure relates to wireless communications, and in particular, to configurations for supporting artificial intelligence (AI)/machine learning (ML) model drift detection based on conditional statistical metrics.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between user equipment (UE). The 3GPP is also developing standards for Sixth Generation (6G) wireless communication networks.

### AI/ML Models

The ability of AI to “learn” may create advantageous policies or strategies directly based on data instead of relying on human logic, symbolic modeling, and/or analysis. AI/ML enabled solutions may, for example, employ data-driven learning where the models learn the underlying data distributions and relationships between the inputs and outputs, often without the need for human understanding the underlying complex relationship between the input variables and output variables. ML has been found to be an effective tool in radio positioning, for instance, and 3GPP is currently investigating AI/ML based positioning methods for achieving high positioning accuracy in challenging deployment scenarios, such as a high probability of non-line-of-sight radio propagation environments.

### Positioning Based on Radio Signal Measurements Data Learning

3GPP is currently studying AI based methods for indoor positioning. FIG. 1 is a diagram which illustrates an example scenario of radio propagation, in which different radio propagations may result in different radio communication channel features, such as channel coherent bandwidths, channel variations over time and space, etc. One notable feature is that the channel may exhibit rich multipath characteristics in indoor environments, especially when the indoor environment is densely scattered with so-called clutters, such as machines, assembly lines, and storage shelves in an indoor factory, etc. Line of sight (LOS) radio propagation paths between the network node (e.g., radio base station, Transmission-Reception Point (TRP), etc.) and the wireless device (User-terminal or UE, for instance) may rarely be available in many environment. The actual radio propagation environment may shape the channel states to be spatially selective and dominated by non-line-of-sight (NLOS) radio paths, for example. Hence, a conventional triangularization or trilateration method assuming all radio paths being LOS may exhibit an unsatisfactory performance under many real world conditions.

Thus, AI/ML based positioning methods are under development to improve positioning accuracy, especially for the heavy NLOS environments where the conventional methods may often fail. Due to constant time-varying environmental change, many positioning estimation models including machine learning (ML) model may exhibit some performance drift under certain conditions.

### Model Monitoring

Positioning integrity may be used as a measure of trust in the accuracy of the position-related estimation/data provided by the positioning system and the ability to provide timely and valid warnings to the Location Services (LCS) client when the positioning system does not fulfil the condition for intended operation. Integrity may focus on the tail of the positioning error distribution (i.e., the rare events), with the aim of keeping the probability of hazardous events extremely low. For example, <10⁻⁷/hr Target Integrity Risk (TIR) translates to one failure permitted every 10 million hours (equivalent to 1142 years approximately).

Hence, to secure positioning integrity, it may be necessary to monitor the pretrained ML model for positioning on its possible drifts in performance, due, e.g., radio environment changes, device failure, interference, etc., which may cause measurement distortions to radio signals.

Radio propagation environments may be constantly changing. For example, in some indoor factory scenarios, objects may move around, enter or exit an area, indoor furniture may change location, etc. These causes may change the measurement data set and the relationship between AI/ML model inputs and their model outputs. This may result in drift of an AI and/or ML model. The “true” values of model output may also be referred to as “ground truth labels”, or “labels” for short, which is a concept often used in training data collections for supervised learning.

Recent investigations of AI/ML-based UE positioning have indicated that the positioning accuracy may be improved substantially compared to conventional positioning methods, for example, in deployment scenarios dominated by NLOS. However, for some UE hosted AI/ML fingerprinting methods, if the AI model is trained with a dataset collected in a specific radio propagation environment, it may often encounter generalization problems, i.e., the model performance may degrade when the UE experiences an environment different from that of the training environment. The environmental change may be caused, e.g., by movements of objects in the surroundings, and/or the movement of UE itself (e.g., the UE moves from outdoor to indoor, or moves from one room to another room), or by a variety of other causes.

When the model performance deteriorates, a model update may be used to maintain the required model performance. However, online re-training or (fine-) tuning in real time is often not practically feasible. This may severely impact the positioning accuracy integrity of AI/ML based positioning methods in some cases. Therefore, there is a need to introduce methods to mitigate such generalization issues and improve continuous service of high accuracy positioning of the target UE.

### SUMMARY

Some embodiments advantageously provide methods, systems, and apparatuses for supporting AI/ML model drift detection based on conditional statistical metrics, e.g., in a wireless communication system.

Generalization issues for an AI/ML model may arise when the model becomes inappropriate, e.g., when the mapping relationship between model inputs and model outputs has changed, as compared to the mapping learned from the training dataset(s), i.e., model drift has occurred, which may cause the previously trained model to become unsuitable for the new environment.

For example, statistically, model drift may be defined as occurring when the joint distribution P(V,S) between model input V and model output S has changed. This may occur due to several reasons, such as:
a) The conditional distribution of model output conditioned on model input V, P(S|V) has changed, or
b) P(V|S) have changed.

However, these distribution functions may, in some cases, be difficult to obtain due, e.g., to high computational complexity and/or the need for a relatively large number of data points. The model input V typically is characterized by high dimensionality (e.g., V contains tens or hundreds of features), and a large amount of data may need to be collected to derive acceptable statistics on V. In many cases, model output S may also exhibit high dimensionality. Thus, it may be very challenging to calculate the statistics directly.

As described herein, a practical model drift detection method may be implemented for supporting AI/ML model drift detection based on conditional statistical metrics, e.g., in a wireless communication system, which utilizes conditional statistical moments or combination of them in place of the distribution functions. In many cases, embodiments of the present disclosure may substantially reduce computational complexity as compared to existing methods and systems.

As described herein, some embodiments may provide solutions and configurations for model drift monitoring on AI/ML models. The AI/ML models may be deployed for a variety of use cases, for example. In the following, the discussion uses AI/ML based positioning as an example for discussion, but the embodiments are not so limited and may be applied to a variety of other AI/ML use cases.

One or more embodiments of the present disclosure may be implemented, e.g., in a wireless communication system, in a UE and/or network node, etc., as follows:
For an AI/ML model with input v and output s, the model monitoring metric may be calculated (e.g., by UE, by network node, etc.) as a statistical distance between two datasets, where the first dataset is a reference dataset, and the second dataset is an operational dataset.
   The statistical distance may be calculated (e.g., by UE, by network node, etc.) using two statistical knowledge matrices, where the first matrix is for the reference dataset, and the second matrix is for the operational dataset. The statistical distance may be a value calculated to reflect the similarity or difference between the two statistical knowledge matrices.
   For the generation of a statistical knowledge matrix of a given dataset, each element with an index (i, j) of the matrix may be obtained by calculating a certain type or weighted sum of types of descriptive statistics of a first set S_input_{(i,j)} of variable vectors/matrixes v (as a model input), where each v in S_input_{(i,j)} corresponds to a vector/matrix s (as a model output), and s belongs to a second set S_output_{(i,j)}. The descriptive statistics may include, e.g., various types including but not limited to the following examples: measures of variability, central tendency, or skewness of the data set, etc.
   For both the first and second statistical knowledge matrix, the same S_output_{(i,j)} is used in the calculating their elements with an index (i, j).
The model monitoring metric is used (e.g., by UE, by a network node, etc.) to make decisions on model monitoring, such as model drift detection.
   In one example, a statistical distance defined between two datasets is compared (e.g., by UE, by network node, etc.) with one (or more) threshold value(s) to determine whether model drift has occurred when running the model on the operational dataset.

Thus, some embodiments may provide a new metric for detecting model drift of AI/ML models, as compared to existing systems.

According to one aspect of the present disclosure, a UE is provided. UE is configured to determine a first model monitoring metric for a first machine learning, ML, model, the first model monitoring metric being based on a statistical distance between a reference dataset and an operational dataset; and perform at least one action based on the first model monitoring metric.

According to one or more embodiments of this aspect, the reference dataset corresponds to at least a portion of a radio measurement dataset that was used to train the first ML model.

According to one or more embodiments of this aspect, the operational dataset corresponds to a real-time radio measurement dataset provided to the first ML model during a deployment of the first ML model.

According to one or more embodiments of this aspect, based on the first model monitoring metric exceeding a threshold, performing the at least one action comprises causing transmission of an indication that model drift has occurred.

According to one or more embodiments of this aspect, UE is further configured to at least one of switch, tune or deactivate a model based on a model drift indication.

According to one or more embodiments of this aspect, UE is further configured to one of: receive a model drift indication; or determine the model drift indication.

According to one or more embodiments of this aspect, the model drift indication comprises an indication that the statistical distance: is greater than the first threshold and less than or equal to a second threshold, the second threshold being greater than the first threshold; or is greater than the second threshold.

According to one or more embodiments of this aspect, the at least one action comprises one of: a warning signal, based on the statistical distance being greater than the first threshold and less than or equal to the second threshold; or an alarm signal, based on the statistical distance being greater than the second threshold.

According to another aspect of the present disclosure, a method performed by a UE is provided. The method comprises determining a first model monitoring metric for a first machine learning, ML, model, the first model monitoring metric being based on a statistical distance between a reference dataset and an operational dataset; and performing at least one action based on the first model monitoring metric.

According to one or more embodiments of this aspect, the reference dataset corresponds to at least a portion of a radio measurement dataset that was used to train the first ML model.

According to one or more embodiments of this aspect, the operational dataset corresponds to a real-time radio measurement dataset provided to the first ML model during a deployment of the first ML model.

According to one or more embodiments of this aspect, based on the first model monitoring metric exceeding a threshold, performing the at least one action comprises causing transmission of an indication that model drift has occurred.

According to one or more embodiments of this aspect, the method further comprises at least one of switching, tuning or deactivating a model based on a model drift indication.

According to one or more embodiments of this aspect, the method further comprises one of: receiving a model drift indication; or determining the model drift indication.

According to one or more embodiments of this aspect, the model drift indication comprises an indication that the statistical distance: is greater than the first threshold and less than or equal to a second threshold, the second threshold being greater than the first threshold; or is greater than the second threshold.

According to one or more embodiments of this aspect, the at least one action comprises one of: a warning signal, based on the statistical distance being greater than the first threshold and less than or equal to the second threshold; or an alarm signal, based on the statistical distance being greater than the second threshold.

According to another aspect of the present disclosure, a network node is provided. The network node is configured to determine a first model monitoring metric for a first machine learning, ML, model, the first model monitoring metric being based on a statistical distance between a reference dataset and an operational dataset; and perform at least one action based on the first model monitoring metric.

According to one or more embodiments of this aspect, the reference dataset corresponds to at least a portion of a radio measurement dataset that was used to train the first ML model.

According to one or more embodiments of this aspect, the operational dataset corresponds to a real-time radio measurement dataset provided to the first ML model during a deployment of the first ML model.

According to one or more embodiments of this aspect, based on the first model monitoring metric exceeding a threshold, performing the at least one action comprises causing transmission of an indication that model drift has occurred.

According to one or more embodiments of this aspect, network node is further configured to at least one of switch, tune or deactivate a model based on a model drift indication.

According to one or more embodiments of this aspect, network node is further configured to one of: receive a model drift indication; or determine the model drift indication.

According to one or more embodiments of this aspect, the model drift indication comprises an indication that the statistical distance: is greater than the first threshold and less than or equal to a second threshold, the second threshold being greater than the first threshold; or is greater than the second threshold.

According to one or more embodiments of this aspect, the at least one action comprises one of: a warning signal, based on the statistical distance being greater than the first threshold and less than or equal to the second threshold; or an alarm signal, based on the statistical distance being greater than the second threshold.

According to another aspect of the present disclosure, a method performed by a network node is provided. The method comprises determining a first model monitoring metric for a first machine learning, ML, model, the first model monitoring metric being based on a statistical distance between a reference dataset and an operational dataset; and performing at least one action based on the first model monitoring metric.

According to one or more embodiments of this aspect, the reference dataset corresponds to at least a portion of a radio measurement dataset that was used to train the first ML model.

According to one or more embodiments of this aspect, the operational dataset corresponds to a real-time radio measurement dataset provided to the first ML model during a deployment of the first ML model.

According to one or more embodiments of this aspect, based on the first model monitoring metric exceeding a threshold, performing the at least one action comprises causing transmission of an indication that model drift has occurred.

According to one or more embodiments of this aspect, the method further comprises at least one of switching, tuning or deactivating a model based on a model drift indication.

According to one or more embodiments of this aspect, the method further comprises one of: receiving a model drift indication; or determining the model drift indication.

According to one or more embodiments of this aspect, the model drift indication comprises an indication that the statistical distance: is greater than the first threshold and less than or equal to a second threshold, the second threshold being greater than the first threshold; or is greater than the second threshold.

According to one or more embodiments of this aspect, the at least one action comprises one of: a warning signal, based on the statistical distance being greater than the first threshold and less than or equal to the second threshold; or an alarm signal, based on the statistical distance being greater than the second threshold.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram illustrating an example wireless communication environment;

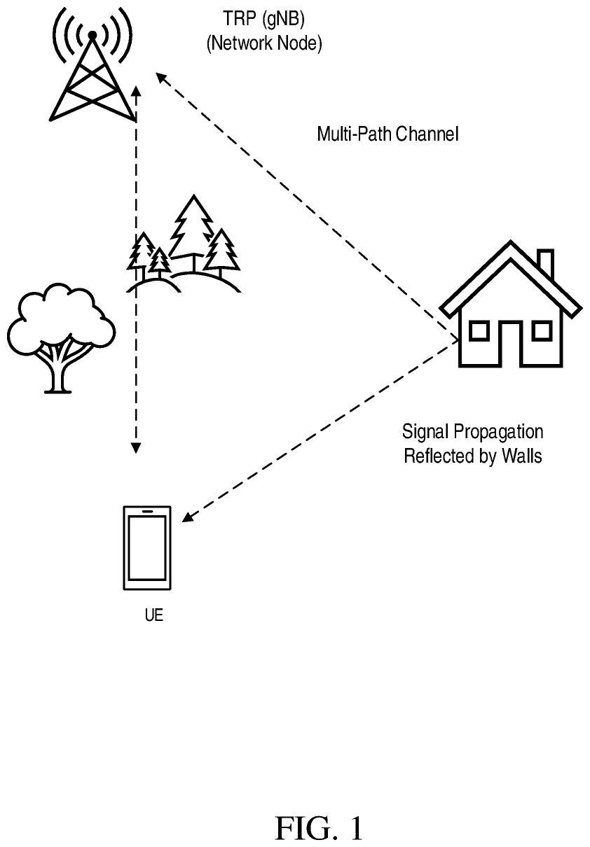

FIG. 2 is a schematic diagram of an example network architecture illustrating a communication system according to the principles in the present disclosure;

FIG. 3 is a block diagram of a network node communicating with a UE over an at least partially wireless connection according to some embodiments of the present disclosure;

FIG. 4 is a flowchart of an example process in a UE for supporting AI/ML model drift detection based on conditional statistical metrics according to some embodiments of the present disclosure.

FIG. 5 is a flowchart of another example process in a UE for supporting AI/ML model drift detection based on conditional statistical metrics according to some embodiments of the present disclosure;

FIG. 6 is a flowchart of an example process in a network node for supporting AI/ML model drift detection based on conditional statistical metrics according to some embodiments of the present disclosure;

FIG. 7 is a flowchart of an example process in a network node for supporting AI/ML model drift detection based on conditional statistical metrics according to some embodiments of the present disclosure;

FIG. 8 is a flowchart of another example process in a UE according to some embodiments of the present disclosure;

FIG. 9 is a flowchart of another example process in a network node according to some embodiments of the present disclosure; and

FIG. 10 is a graph illustrating example statistics including cumulative error density functions and their corresponding data set distances, according to some embodiments of the present disclosure.

### DETAILED DESCRIPTION

Before describing in detail example embodiments, it is noted that the embodiments reside primarily in combinations of apparatus components and processing steps related to configurations for supporting AI/ML model drift detection based on conditional statistical metrics. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a user equipment (UE) such as a wireless device (WD) or a radio network node.

In some embodiments, the non-limiting terms wireless device (WD) or a user equipment (UE) are used interchangeably. The UE herein can be any type of wireless device capable of communicating with a network node or another UE over radio signals, such as wireless device (WD). The UE may also be a radio communication device, target device, device to device (D2D) WD, machine type WD or UE capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a UE or a network node may be distributed over a plurality of UEs and/or network nodes. In other words, it is contemplated that the functions of the network node and UE described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide configurations and methods for supporting AI/ML model drift detection based on conditional statistical metrics.

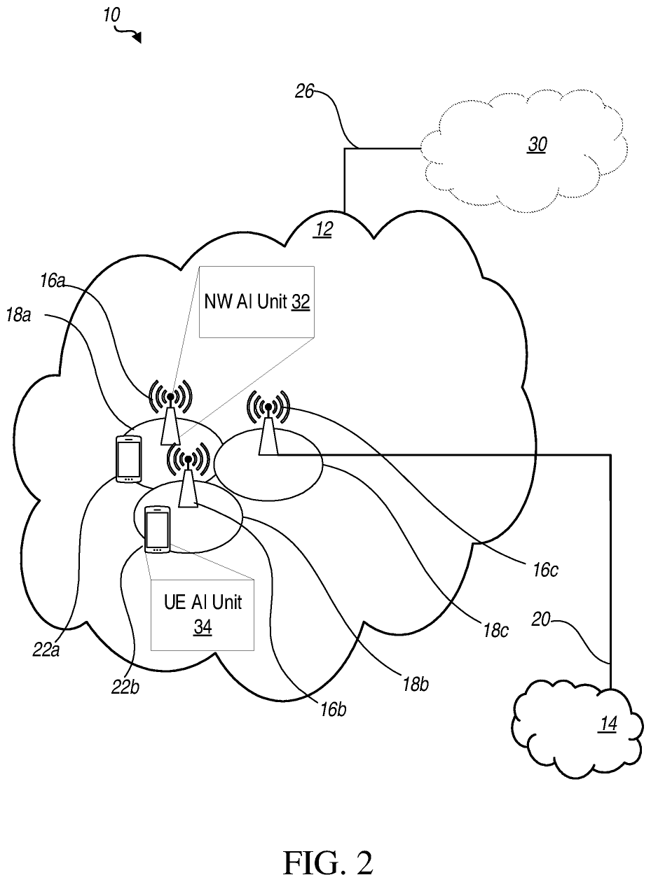

Referring again to the drawing figures, in which like elements are referred to by like reference numerals, there is shown in FIG. 2 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first user equipment (UE) 22a located in coverage area 18a is configured to wirelessly connect to, or be paged by, the corresponding network node 16a. A second UE 22b in coverage area 18b is wirelessly connectable to the corresponding network node 16b. While a plurality of UEs 22a, 22b (collectively referred to as UEs 22) are illustrated in this example, the disclosed embodiments are equally applicable to a situation where a sole UE is in the coverage area or where a sole UE is connecting to the corresponding network node 16. Note that although only two UEs 22 and three network nodes 16 are shown for convenience, the communication system may include many more UEs 22 and network nodes 16.

Also, it is contemplated that a UE 22 can be in simultaneous communication and/or configured to separately communicate with more than one network node 16 and more than one type of network node 16. For example, a UE 22 can have dual connectivity with a network node 16 that supports LTE and the same or a different network node 16 that supports NR. As an example, UE 22 can be in communication with an eNB for LTE/E-UTRAN and a gNB for NR/NG-RAN.

The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

A network node 16 is configured to include a NW AI unit 32 which is configured for supporting AI/ML model drift detection based on conditional statistical metrics. A UE 22 is configured to include a UE AI unit 34 which is configured for supporting AI/ML model drift detection based on conditional statistical metrics.

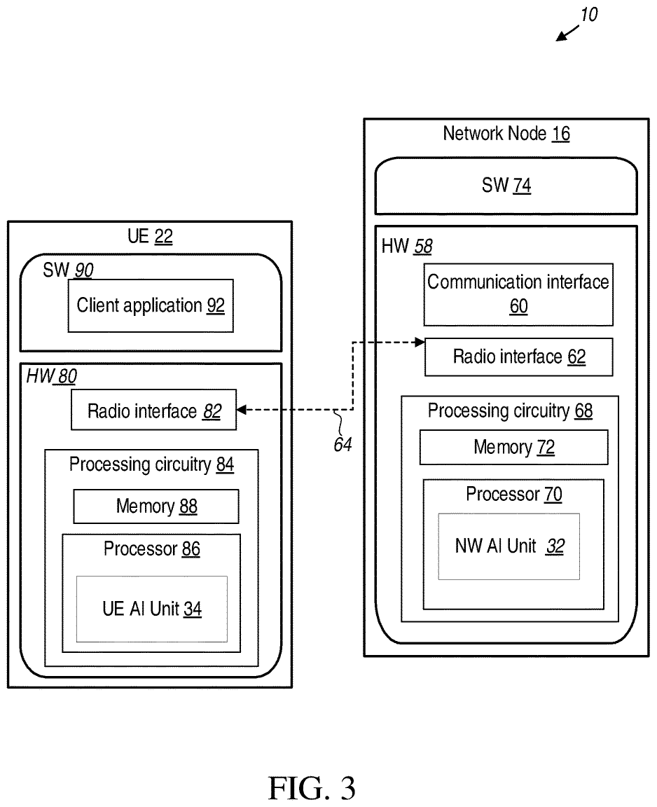

Example implementations, in accordance with an embodiment, of the UE 22 and network node 16 discussed in the preceding paragraphs will now be described with reference to FIG. 3.

The communication system 10 includes a network node 16 provided in a communication system 10 and including hardware 58 enabling it to communicate with the UE 22. The hardware 58 may include a communication interface 60 for setting up and maintaining a wired or wireless connection with an interface of a different communication device of the communication system 10, as well as a radio interface 62 for setting up and maintaining at least a wireless connection 64 with a UE 22 located in a coverage area 18 served by the network node 16. The radio interface 62 may be formed as or may include, for example, one or more RF transmitters, one or more RF receivers, and/or one or more RF transceivers.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include NW AI unit 32 configured for supporting AI/ML model drift detection based on conditional statistical metrics.

The communication system 10 further includes the UE 22 already referred to. The UE 22 may have hardware 80 that may include a radio interface 82 configured to set up and maintain a wireless connection 64 with a network node 16 serving a coverage area 18 in which the UE 22 is currently located. The radio interface 82 may be formed as or may include, for example, one or more RF transmitters, one or more RF receivers, and/or one or more RF transceivers.

The hardware 80 of the UE 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the UE 22 may further comprise software 90, which is stored in, for example, memory 88 at the UE 22, or stored in external memory (e.g., database, storage array, network storage device, etc.) accessible by the UE 22. The software 90 may be executable by the processing circuitry 84. The software 90 may include a client application 92. The client application 92 may be operable to provide a service to a human or non-human user via the UE 22. The client application 92 may interact with the user to generate the user data that it provides.

The processing circuitry 84 may be configured to control any of the methods and/or processes described herein and/or to cause such methods, and/or processes to be performed, e.g., by UE 22. The processor 86 corresponds to one or more processors 86 for performing UE 22 functions described herein. The UE 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to UE 22. For example, the processing circuitry 84 of the UE 22 may include a UE AI unit 34 configured for supporting AI/ML model drift detection based on conditional statistical metrics.

In some embodiments, the inner workings of the network node 16 and UE 22 may be as shown in FIG. 2 and independently, the surrounding network topology may be that of FIG. 3.

The wireless connection 64 between the UE 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve.

In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the UE 22, and/or preparing/terminating/maintaining/supporting/ending in receipt of a transmission from the UE 22.

In some embodiments, the UE 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 2 and 3 show various “units” such as NW AI unit 32, and UE AI unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

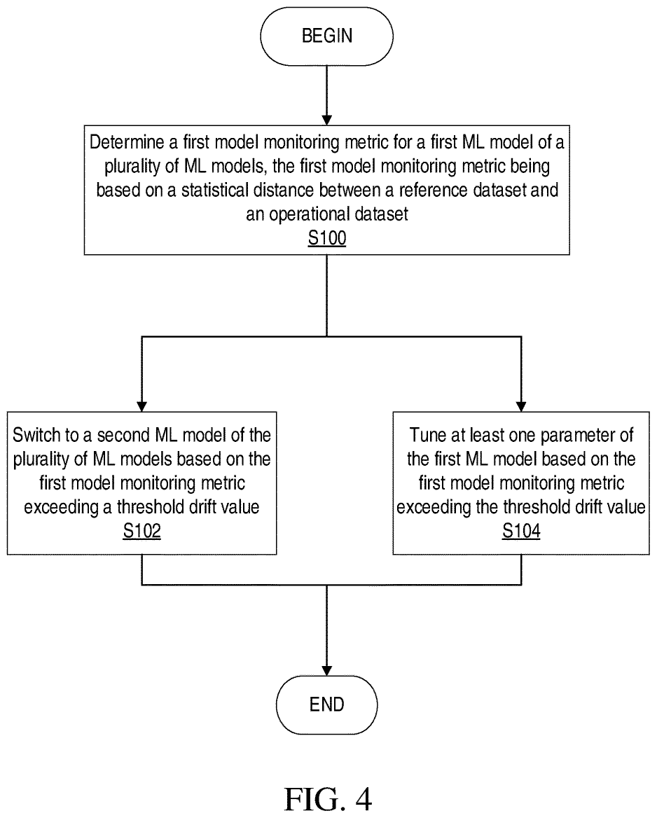

FIG. 4 is a flowchart of an example process in a UE 22 according to some embodiments of the present disclosure for supporting AI/ML model drift detection based on conditional statistical metrics. One or more blocks described herein may be performed by one or more elements of UE 22 such as by one or more of processing circuitry 84 (including the UE AI unit 34), processor 86, radio interface 82 and/or communication interface 60. UE 22 is configured to determine (Block S100) a first model monitoring metric for a first ML model of a plurality of ML models, the first model monitoring metric being based on a statistical distance between a reference dataset and an operational dataset. UE 22 is configured to, optionally, either: switch (Block S102) to a second ML model of the plurality of ML models based on the first model monitoring metric exceeding a threshold drift value, or tune (Block S104) at least one parameter of the first ML model based on the first model monitoring metric exceeding the threshold drift value. For example, in some embodiments, the determination whether to switch or to tune may be based on configuration settings/information and/or based on comparing the metric to additional threshold values (e.g., if it exceeds a first threshold but is less than a higher second threshold, tune, other, if it exceeds both the first threshold and the second threshold, then switch, if it is less than both thresholds, then do not switch or tune the model).

In some embodiments, the first model monitoring metric for the first ML model is determined by determining a first statistical knowledge matrix for the reference dataset and a second statistical knowledge matrix for the operational dataset, and comparing the first statistical knowledge matrix with the second statistical knowledge matrix. In some embodiments, the first statistical knowledge matrix is determined based on one or more of at least one first conditional statistic moment of the first knowledge matrix, at least one second conditional statistic moment of the second knowledge matrix, and/or a first weighted sum of the at least one first conditional statistic moment and the at least one second conditional statistic moment. In some embodiments, the reference dataset corresponds to at least a portion of a radio measurement dataset which was used to train the first ML model for location inference. In some embodiments, the operational dataset corresponds to a real-time radio measurement dataset provided to the first ML model during a deployment of the first ML model for location inference. In some embodiments, the UE 22 is further configured to receive and/or store the plurality of ML models.

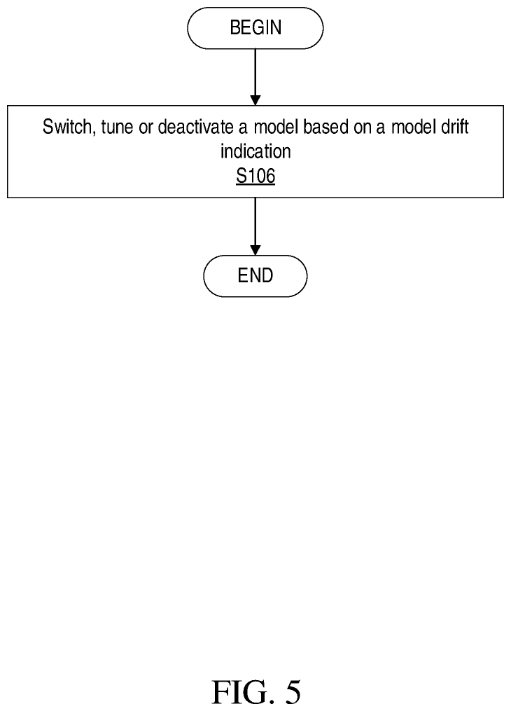

FIG. 5 is a flowchart of another example process in a UE 22 according to some embodiments of the present disclosure for supporting AI/ML model drift detection based on conditional statistical metrics. One or more blocks described herein may be performed by one or more elements of UE 22 such as by one or more of processing circuitry 84 (including the UE AI unit 34), processor 86, radio interface 82 and/or communication interface 60. UE 22 is configured to (Block S106) switch, tune or deactivate a model based on a model drift indication.

In some embodiments, the UE 22 is further configured to receive the model drift indication (e.g., from a network node 16, from another UE 22, etc.), or may determine the model drift indication (e.g., using UE AI unit 34). For example, network node 16, UE 22, etc., may be configured to transmit model drift indications, e.g., triggered by model drift monitoring parameters/values/etc., exceeding various thresholds, as a result of related model drift alarms/alerts/etc., as described herein. In some embodiments, the drift indication is an indication of statistical distance between first and second datasets of the model.

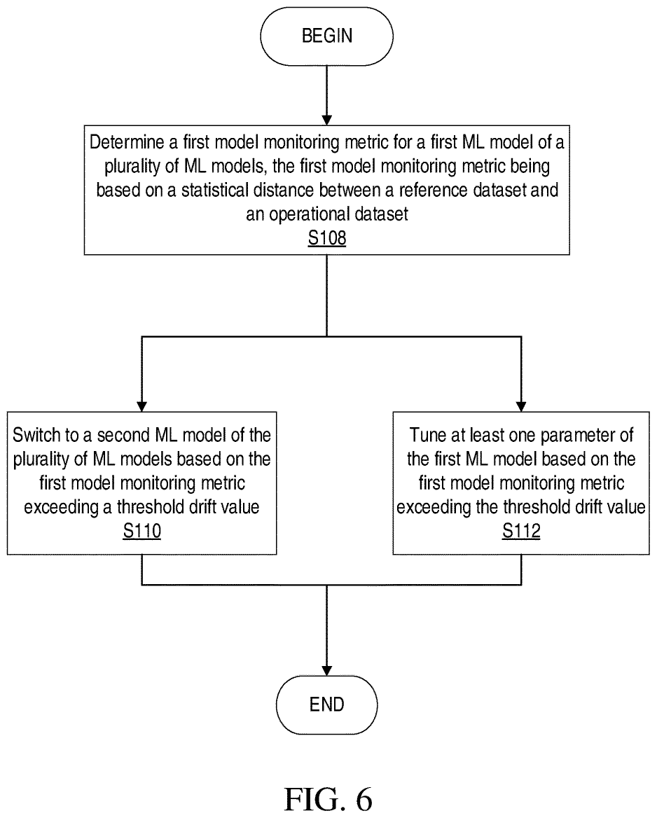

FIG. 6 is a flowchart of an example process in a network node 16 for supporting AI/ML model drift detection based on conditional statistical metrics. One or more blocks described herein may be performed by one or more elements of network node 16 such as by one or more of processing circuitry 68 (including the NW AI unit 32), processor 70, radio interface 62 and/or communication interface 60. Network node 16 is configured to determine (Block S108) a first model monitoring metric for a first ML model of a plurality of ML models, the first model monitoring metric being based on a statistical distance between a reference dataset and an operational dataset. Network node 16 is configured to, optionally, either: switch (Block S110) to a second ML model of the plurality of ML models based on the first model monitoring metric exceeding a threshold drift value, or tune (Block S112) at least one parameter of the first ML model based on the first model monitoring metric exceeding the threshold drift value.

In some embodiments, the first model monitoring metric for the first ML model is determined by determining a first statistical knowledge matrix for the reference dataset and a second statistical knowledge matrix for the operational dataset, and comparing the first statistical knowledge matrix with the second statistical knowledge matrix. In some embodiments, the first statistical knowledge matrix is determined based on one or more of at least one first conditional statistic moment of the first knowledge matrix, at least one second conditional statistic moment of the second knowledge matrix, and/or a first weighted sum of the at least one first conditional statistic moment and the at least one second conditional statistic moment. In some embodiments, the reference dataset corresponds to at least a portion of a radio measurement dataset which was used to train the first ML model for location inference. In some embodiments, the operational dataset corresponds to a real-time radio measurement dataset provided to the first ML model during a deployment of the first ML model for location inference. In some embodiments, the UE 22 is further configured to receive and/or store the plurality of ML models.

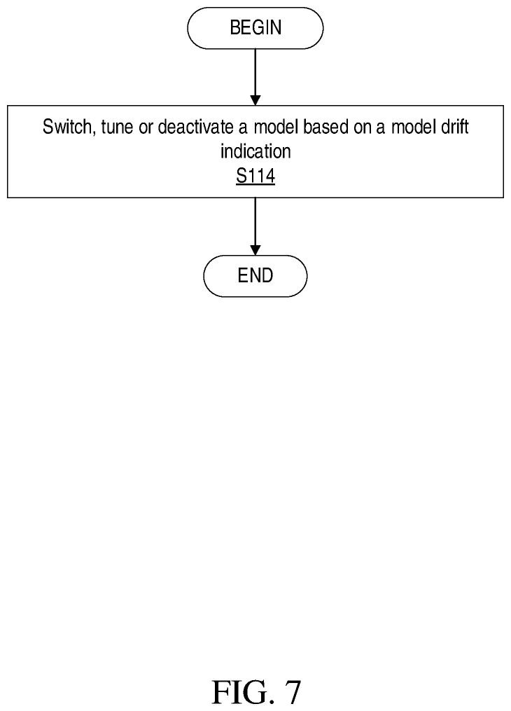

FIG. 7 is a flowchart of another example process in a network node 16 for supporting AI/ML model drift detection based on conditional statistical metrics. One or more blocks described herein may be performed by one or more elements of network node 16 such as by one or more of processing circuitry 68 (including the NW AI unit 32), processor 70, radio interface 62 and/or communication interface 60. Network node 16 is configured to (Block S114) switch, tune or deactivate a model based on a model drift indication.

In some embodiments, the network node 16 is further configured to receive the model drift indication (e.g., from another network node 16, from a UE 22, etc.), or may determine the model drift indication (e.g., using NW AI unit 32). In some embodiments, the drift indication is an indication of statistical distance between first and second datasets of the model.

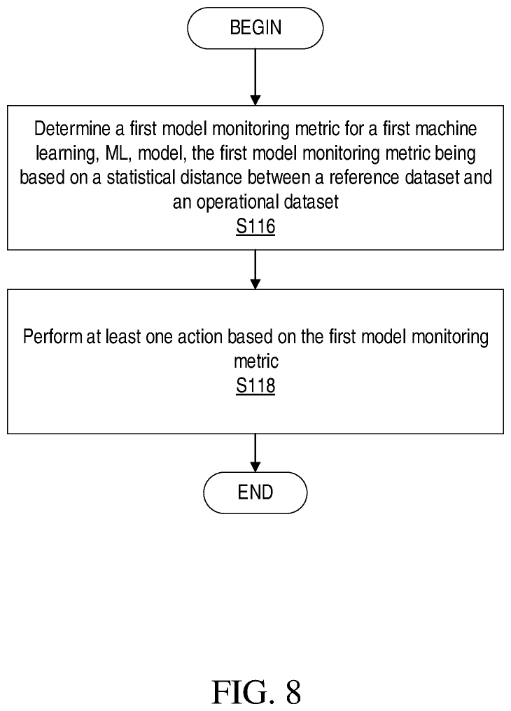

FIG. 8 is a flowchart of another example process in a UE 22 according to some embodiments of the present disclosure for supporting AI/ML model drift detection based on conditional statistical metrics. One or more blocks described herein may be performed by one or more elements of UE 22 such as by one or more of processing circuitry 84 (including the UE AI unit 34), processor 86, radio interface 82 and/or communication interface 60. UE 22 is configured to determine (Block S116) a first model monitoring metric for a first machine learning, ML, model, the first model monitoring metric being based on a statistical distance between a reference dataset and an operational dataset. UE 22 is configured to perform (Block S118) at least one action based on the first model monitoring metric.

In some embodiments, the reference dataset corresponds to at least a portion of a radio measurement dataset that was used to train the first ML model.

In some embodiments, the operational dataset corresponds to a real-time radio measurement dataset provided to the first ML model during a deployment of the first ML model.

In some embodiments, based on the first model monitoring metric exceeding a threshold, performing the at least one action comprises causing transmission of an indication that model drift has occurred.

In some embodiments, UE 22 is further configured to at least one of switch, tune or deactivate a model based on a model drift indication.

In some embodiments, UE 22 is further configured to one of: receive a model drift indication; or determine the model drift indication.

In some embodiments, the model drift indication comprises an indication that the statistical distance: is greater than the first threshold and less than or equal to a second threshold, the second threshold being greater than the first threshold; or is greater than the second threshold.

In some embodiments, the at least one action comprises one of: a warning signal, based on the statistical distance being greater than the first threshold and less than or equal to the second threshold; or an alarm signal, based on the statistical distance being greater than the second threshold.

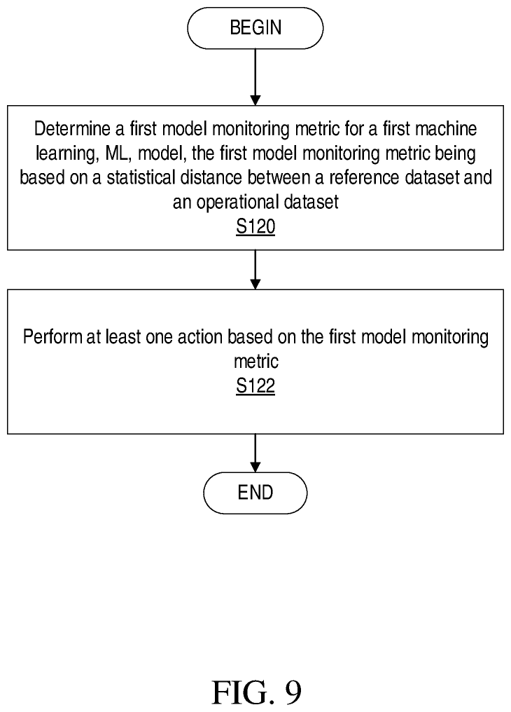

FIG. 9 is a flowchart of another example process in a network node 16 for supporting AI/ML model drift detection based on conditional statistical metrics. One or more blocks described herein may be performed by one or more elements of network node 16 such as by one or more of processing circuitry 68 (including the NW AI unit 32), processor 70, radio interface 62 and/or communication interface 60. Network node 16 is configured to determine (Block S120) a first model monitoring metric for a first machine learning, ML, model, the first model monitoring metric being based on a statistical distance between a reference dataset and an operational dataset. Network node 16 is configured to perform (Block S122) at least one action based on the first model monitoring metric.

In some embodiments, the reference dataset corresponds to at least a portion of a radio measurement dataset that was used to train the first ML model.

In some embodiments, the operational dataset corresponds to a real-time radio measurement dataset provided to the first ML model during a deployment of the first ML model.

In some embodiments, based on the first model monitoring metric exceeding a threshold, performing the at least one action comprises causing transmission of an indication that model drift has occurred.

In some embodiments, network node 16 is further configured to at least one of switch, tune or deactivate a model based on a model drift indication.

In some embodiments, network node 16 is further configured to one of: receive a model drift indication; or determine the model drift indication.

In some embodiments, the model drift indication comprises an indication that the statistical distance: is greater than the first threshold and less than or equal to a second threshold, the second threshold being greater than the first threshold; or is greater than the second threshold.

In some embodiments, the at least one action comprises one of: a warning signal, based on the statistical distance being greater than the first threshold and less than or equal to the second threshold; or an alarm signal, based on the statistical distance being greater than the second threshold.

Having described the general process flow of arrangements of the disclosure and having provided examples of hardware and software arrangements for implementing the processes and functions of the disclosure, the sections below provide details and examples of arrangements for supporting AI/ML model drift detection based on conditional statistical metrics.

Some embodiments provide configurations and methods for AI/ML model drift detection based on conditional statistical metrics. For purposes of this disclose, the use case of AI/ML based positioning is used as illustration. While positioning is a typical use case of AI/ML for future-generation of wireless communications, this is a non-limiting example for illustrating the methodologies described herein. It is to be understood by those skilled in the art that the same methodologies and design principles can be extended to many other use cases.

It is also noted that the disclosed methodologies and design principles may be applied to AI/ML model deployed in various entities in the wireless communications networks, including but not limited to a UE 22 and/or a network node 16, for instance.

In some embodiments a general term “network node” is used, which may correspond to any type of radio network node or any network node (as described above), which communicates with a UE 22 and/or with another network node 16.

### General Framework of Model Monitoring

In one or more embodiments, methods and configurations for performing model monitoring (also known as model drift detection) of an AI/ML model may be described as follows.

In some embodiments, a model drift detection (MDD) unit or function (e.g., as implemented in a NW AI unit 32, UE AI unit 34, etc.) is configured for computing two statistical knowledge matrices, one for a reference dataset, and another for an operational dataset.

For example, the statistical knowledge matrix may be defined and obtained (e.g., by UE 22 and/or network node 16) by calculating the conditional statistic moments. The conditional statistic moments, such as m(v|s) or m(s|v), or m(v,s), etc., may be obtained using data in a collected and stored dataset, where v is a datapoint of observable measurements, such as a radio measurement datapoint, s is identifying datapoint of a v, an s provides the quantitative type for use in analytics and business decision-making or context of a v. A conditional statistic moment may be regarded as a statistical knowledge matrix on the given dataset, for example.

In the above, the “reference dataset” may typically be the training data set which was used to train and obtain the deployed model. Other variants may also be used for the reference dataset, for example, the reference dataset may be a smaller dataset that shares the same attributes (or at least some of the same attributes) as the training dataset, but which may be reduced in size or adjusted in other manner, so that it may provide more efficient storage and computation at the model monitoring stage. In the above, the “operational dataset” may refer to the real-time data the model (e.g., as implemented by UE 22 and/or network node 16) experiences during model deployment.

In some embodiments, as an alternative of using a conditional statistic moment directly, a function of conditional statistic moments may be used as the statistical knowledge matrix. For example, the function may be a weighted sum of moments, which may be defined and calculated (e.g., by UE 22 and/or network node 16) as a statistical knowledge matrix on a model training dataset and the online operational data set. The weighting coefficients may be determined according to the needs of the specific model and scenario. Engineering optimization may be used to select the most appropriate coefficients, for example.

In some embodiments, a predefined distance function may be applied (e.g., by UE 22 and/or network node 16) to the statistical knowledge matrices of the reference dataset and the online operational dataset. The two statistical knowledge matrices may be used as inputs to the distance function for determining the statistical differences among datasets, for example. This statistical difference may then be used (e.g., by UE 22 and/or network node 16) as a metric to detect the model drift. In some embodiments, this statistical distance may be a single value which represents the difference between the operational dataset with and the reference dataset, which may be the training dataset or a modified version of it, for example.

In some embodiments, the statistical distance as obtained in the above-described step may be compared with a predefined threshold, e.g., to make a model monitoring decision (e.g., by UE 22 and/or network node 16). For example, if the statistical distance between datasets is larger than the threshold, then a model drift has been detected (e.g., by UE 22 and/or network node 16). A warning or alarm signal can be sent (i.e., a flag is set to true, a notification is issued to monitoring devices or applications, appropriate network node 16 and/or UE 22 actions are triggered based on configuration information, etc.).

For example, if the statistical difference between two datasets, such as a reference dataset and the operational dataset, is larger than a threshold, this may correspond an indication that the model trained using the training dataset is not likely to work properly for the current deployment scenario and/or configuration. Thus, a model drift may be detected and declared (e.g., by UE 22 and/or network node 16), a warning or alarm signal can be sent by the model drift detection unit (e.g., as implemented by UE 22 and/or network node 16). The warning signal may be a lower-level alert signal, for example, to indicate that the model is not working well, but no immediate action may be necessary, under some conditions and/or configurations. An alarm signal, for example, may indicate that the model performance has deteriorated substantially and/or for an extended period, and may indicate that action(s) need to be taken to address the problem. When an alarm signal is sent (e.g., to one or more monitoring devices, other UEs 22, other network nodes 16, etc.), model management actions may be taken (e.g., by UE 22 and/or network node 16) during the model deployment, e.g., based on configuration information stored in one or more network entities, such as model switching and/or model (fine-) tuning, and/or model deactivation.

### Conditional Data Statistics for Model Monitoring

For two variable matrixes/vectors v and s, conditional statistic moments m(v/s) may be defined as any one or more of the following: (a) the first order moment of the v conditioned on s, i.e., mean of v conditioned on s, (b) the second order moment of the v conditioned on s, i.e., variance matrix of v conditioned on s, or (c) higher order moments such as 3rd or 4th order moments. Similarly, conditional statistic moments may be defined for m(s|v).

In some embodiments, a variable vector with a smaller dimension may be used as condition(s), given a limited number of data points in a data set. For example, for AI/ML based positioning use cases, s is often set to the UE 22 location. When only horizontal UE 22 location is used, variable s may be set to the two-dimensional vector of UE 22 horizontal location coordinates (x,y). Alternatively, if both horizontal and vertical UE 22 location are used, then variable s may be set to the three-dimensional vector of UE 22 coordinates (x,y,z). For simplicity, in the discussion below, it is assumed that s=(x, y), i.e., a horizontal coordinate.

V is typically a vector of a large dimension to represent radio signal feature measurements, such as CSI or RSRP or RSRP per path (RSRPP).

In some embodiments, the mean of variable vectors may be expressed and calculated (e.g., by UE 22 and/or network node 16) as:

$$\text{?} = {E}_{\text{?}} ( v \vert s )$$

$$\text{?} \text{indicates text missing or illegible when filed}$$

where Eₚ_{ᵥ} stands for the statistical expectation of a variable (vector, matrix).

The variance matrix may be denoted and calculated (e.g., by UE 22 and/or network node 16) as:

$${C}_{\text{?}} = {C}_{\text{?}} ( v \vert s )$$

$$\text{?} \text{indicates text missing or illegible when filed}$$

Specifically,

$${c}_{\text{?}} = {E}_{\text{?}} ( ( v \vert s - {μ}_{\text{?}} ) {( v \vert s - {μ}_{\text{?}} )}^{H}$$

$$\text{?} \text{indicates text missing or illegible when filed}$$

In many embodiments, due to limited data points of v conditioned on an s, to obtain a statistic in a two-dimensional spatial grid of small zones instead of a point, the following variant of steps in calculating the mean and variance matrix may be used (e.g., by UE 22 and/or network node 16):
1. Form a grid of anchoring points, each is with coordinates (xᵢⱼ, yᵢⱼ) as the following,

$${g}_{ij} = ( {x}_{ij} ∈ [ {x}_{min} , {x}_{max} ] , {y}_{ij} ∈ [ {y}_{min} , {y}_{max} ] ) ,$$

$$i = 0 , 1 , 2 , … , m ; j = 0 , 1 , 2 , … , n$$

Each gᵢⱼ may represent a location point in the service area (e.g., coverage area(s) 18). Collectively, the set of gᵢⱼ define a set of spatially sampled points, which forms a grid to cover the whole serving area of a positioning service. The dimension of the whole area may be defined by [xₘᵢₙ, xₘₐₓ]d [yₘᵢₙ, yₘₐₓ] set of gᵢⱼ points are either in a uniform distribution (i.e., square grid points) or in fashion of a random distribution. For example, in some embodiments, computation (e.g., by UE 22 and/or network node 16) may utilize a uniform distribution of such grid points, e.g., such that the grid points may be arranged to form a matrix in a processable format.
2. A grid matrix Gₛ may be obtained as follows,

$${G}_{s} = [ \begin{matrix}{g}_{00} & {g}_{01} & … & {g}_{0 n} \\ {g}_{10} & … & … & … \\ … & … & … & … \\ {g}_{n 0} & {g}_{n 1} & … & {g}_{mn}\end{matrix} ]$$

Here, gᵢⱼ is the anchor point at the center of a small zone, i.e., each gᵢⱼ defines a small zone (e.g., a sub-area of a coverage area 18). Collectively the small zones corresponding to the set of gᵢⱼ cover the entire service area.

To calculate the mean of v for a predefined zone, the mean calculation may be applied (e.g., by UE 22 and/or network node 16) to all v in a zone. For a given zone defined by gᵢⱼ, the mean may be mathematically denoted as:

$${μ}_{v \vert {g}_{ij}} = {E}_{{p}_{v}} ( v \vert d ( s , {g}_{ij} ) < γ )$$

Thus, for each gᵢⱼ, the mean calculation may be applied (e.g., by UE 22 and/or network node 16) to a subset of v values obtained from the given dataset, where the subset of v values corresponds to the model input values that map to the targeted model output s subset, where the s subset is within the zone defined by gᵢⱼ and parameter γ as a zone radius.

The dataset as described herein may be either reference dataset (which is typically a training dataset or a modified version of it) or an operational dataset, for example.

The γ is a parameter that defines the size of a zone, such that points within the zone may be regarded as for a same label s (in measurement, usually s has an error range), the actual value of it may be determined according to the label data status, such as labeling accuracy, or, in AI positioning, it may be defined and calculated (e.g., by UE 22 and/or network node 16) as a zone size for a given square location grid.

For example, in the equation above, d (s, gᵢⱼ) is a distance metric which calculates the distance between vector s and gᵢⱼ.

Furthermore, for a given anchor point gᵢⱼ, a variance matrix may be calculated (e.g., by UE 22 and/or network node 16) according to the following equation:

$${c}_{v \vert {g}_{ij}} = {E}_{{p}_{v}} ( ( v \vert {g}_{ij} - {μ}_{v \vert {g}_{ij}} ) {( v \vert {g}_{ij} - {μ}_{v \vert {g}_{ij}} )}^{H} )$$

Where H stands for a conjugate transpose (a transpose if the variables are of real values) and

$$v {\vert}_{\text{?}} = \{ v \vert d ( s , {g}_{ij} ) < γ \}$$

$$\text{?} \text{indicates text missing or illegible when filed}$$

are a subset of vector v whose label s falls in the zone of gᵢⱼ.
3. With the mean defined and calculated (e.g., by UE 22 and/or network node 16) as described above, calculate a grid matrix of mean matrixes (first order moment) across all the anchor points gᵢⱼ. The full matrix may, for example, be arranged in the following format.

$${U}_{\text{?}} = [ \begin{matrix}{μ}_{\text{?}} & {μ}_{\text{?}} & … & {μ}_{\text{?}} \\ {μ}_{\text{?}} & … & … & … \\ … & … & … & … \\ {μ}_{\text{?}} & {μ}_{\text{?}} & … & {μ}_{\text{?}}\end{matrix} ]$$

$$\text{?} \text{indicates text missing or illegible when filed}$$

Similarly, with the variance defined above, UE 22 and/or network node 16 may be configured to calculate a grid matrix of statistical variance matrixes (second order moment) across all the anchor points gᵢⱼ, for example, as follows.

$${C}_{v \vert g} = [ \begin{matrix}{c}_{v \vert {g}_{00}} & {c}_{v \vert {g}_{01}} & … & {c}_{v \vert {g}_{0 n}} \\ {c}_{v \vert {g}_{10}} & … & … & … \\ … & … & … & … \\ {c}_{v \vert {g}_{m 0}} & {g}_{n 1} & … & {c}_{v \vert {g}_{mn}}\end{matrix} ]$$

### Data Set Distance Calculation:

In some embodiments, to measure the difference between the conditional distributions of the reference dataset and the operational dataset, UE 22 and/or network node 16 may be configured to compute the moment-based statistic knowledge matrices described herein as inputs for distance calculation(s), as an alternative, for example, to using distribution density functions, as the latter may often be difficult to obtain under real world conditions within a satisfactory accuracy and with an acceptable computational complexity.

As an example, the variance matrix may be used as inputs (e.g., by UE 22 and/or network node 16) for calculating the statistical distance between two distributions, as shown in the equation below. The inputs of the equation are two variance matrices, where C_{(v|g)} is the variance matrix calculated using the reference dataset, and C_{(\hat{v}|ĝ)} is the variance matrix calculated using the operational dataset. As denoted by -, a matrix element-wise division may be performed (e.g., by UE 22 and/or network node 16) between C_{(v|g)} and C_{(\hat{v}|ĝ)}. A Frobenius-norm calculation as denoted by ∥⋅∥_{Frob} may be applied to obtain the distance.

$${D}_{d} ( p ( v \vert s ) ‖ q ( \hat{v} \vert \hat{s} ) \dot{=} {‖ {C}_{v , g} ⌀ {C}_{\hat{v} \vert \tilde{g}} ‖}_{Frob}$$

In some embodiments, as an alternative to using a Frobenius-norm, other types of distance calculation may be defined and calculated (e.g., by UE 22 and/or network node 16) to determine the difference between two matrixes, e.g., L1-norm.

While the second order moment (i.e., variance matrix) based statistical knowledge matrix described herein may, in some embodiments, be used as in the equation above to calculate the distance between the reference dataset and the operational dataset, other moments may be used, e.g., first order (i.e., mean), or 3^{rd} order, or 4-th order moments, etc.

In some embodiments, as an alternative to using the variance-based knowledge matrixes as an input to the distance calculation, other formats may be used as the input matrix, for example, a weighted sum of different orders of statistical-moments-based ones may be applied (e.g., by UE 22 and/or network node 16).

Performance metric calculation/reporting management by model drift monitoring (MDM) entity

A statistical distance metric may be considered the model monitoring metric, which may be used (e.g., by UE 22 and/or network node 16) to make model monitoring decisions.

In some embodiments, for example, the distance metric may be calculated (e.g., by UE 22 and/or network node 16) as described herein, and may be compared (e.g., by UE 22 and/or network node 16) to a pre-configured threshold for detecting the model drift.

For example, if D≤Dₜₕᵣₑₛ, then UE 22 and/or network node 16 may determine that no model drift is detected; otherwise, i.e., D>Dₜₕᵣₑₛₕ, then the model drift is determined to have been detected. The statistical distance D may be calculated (e.g., by UE 22 and/or network node 16) according one or more techniques described herein, for example, and Dₜₕᵣₑₛₕ may be the predefined threshold.

In some embodiments, multiple levels of decisions may be made (e.g., by UE 22 and/or network node 16), using two or more thresholds, for example. For instance, with two thresholds and Dₜₕᵣₑₛ<Dₜₕᵣₑₛ,
if D≤Dₜₕᵣ, then UE 22 and/or network node 16 may be configured to determine that no model drift is detected.
if Dₜₕᵣₑₛₕ₁<D≤Dₜₕᵣₑₛ, then there is medium likelihood that model drift has occurred. In this case, a warning signal may be generated by the model drift detection unit (implemented, e.g., by UE 22 and/or network node 16).
Otherwise, i.e., if D>Dₜₕᵣₑₛ, then there is high likelihood that model drift has occurred. In this case, an alarm signal can be generated by the model drift detection unit (implemented, e.g., by UE 22 and/or network node 16).

In some embodiments, the threshold settings and configuration may depend on the specific scenario of the AI model deployment and model accuracy requirements, for example. It may be configured, e.g., according to the targeted model monitoring performance metrics such as false alarm rates and misdetection rates. The particular settings and configurations may be dependent on various implementation engineering optimizations.

Simulation results demonstrating effectiveness of embodiments of the present disclosure

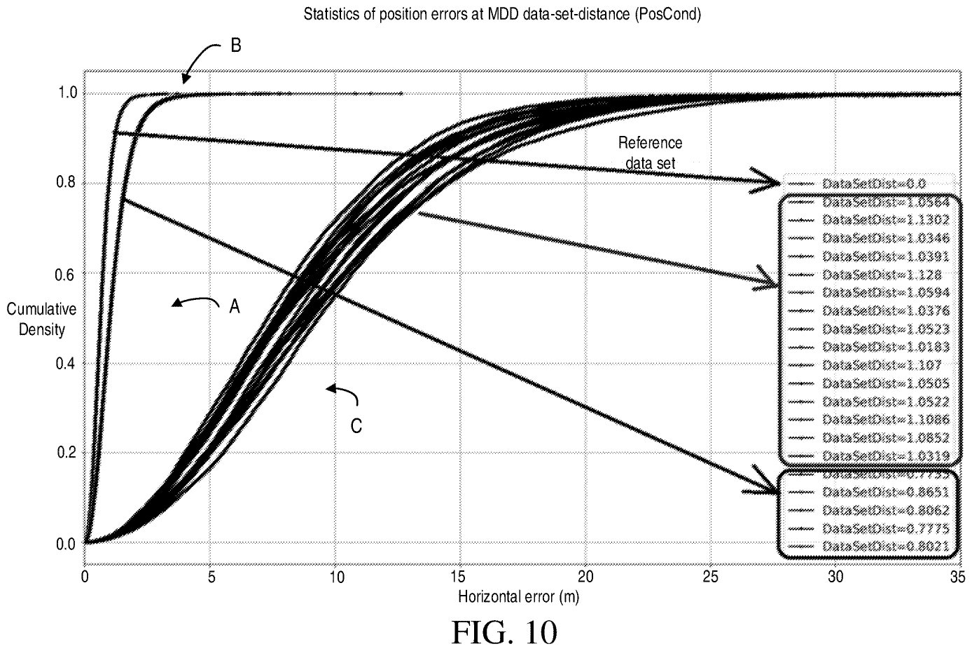

FIG. 10 is a graph illustrating example statistics including cumulative error density functions and their corresponding data set distances, according to some embodiments of the present disclosure. In FIG. 10, cumulative error density functions and their corresponding data set distances, as calculated according to embodiments of the present disclosure, are illustrated in the graph. For example, a cluster of data sets with their distances around 0.7 to 0.8 (marked ‘A’ in FIG. 10) may results a slight model drift as compared to the reference data set (marked ‘B’ in FIG. 10) case, while another cluster of data sets with their distances being greater than 1 (marked ‘C in FIG. 10) may exhibit a severe model drift in performance. In such an example of statistical inspections on datasets, the threshold may, e.g., be set between 0.8 and 1.0 for detecting the possible substantial model drift.

The evaluation results demonstrate the effectiveness of using statistical knowledge matrices described herein to obtain the model monitoring metrics.

### Example Embodiments

Example A1. A UE 22 configured to communicate with a network node 16, the UE 22 configured to, and/or comprising a radio interface and/or processing circuitry configured to:
determine a first model monitoring metric for a first ML model of a plurality of ML models, the first model monitoring metric being based on a statistical distance between a reference dataset and an operational dataset; and
optionally, one of:
   switch to a second ML model of the plurality of ML models based on the first model monitoring metric exceeding a threshold drift value; and
   tune at least one parameter of the first ML model based on the first model monitoring metric exceeding the threshold drift value.

Example A2. The UE 22 of Example A1, wherein the first model monitoring metric for the first ML model is determined by:
determining a first statistical knowledge matrix for the reference dataset and a second statistical knowledge matrix for the operational dataset; and
comparing the first statistical knowledge matrix with the second statistical knowledge matrix.

Example A3. The UE 22 of any one of Examples A1 and A2, wherein the first statistical knowledge matrix is determined based on one or more of:
at least one first conditional statistic moment of the first knowledge matrix;
at least one second conditional statistic moment of the second knowledge matrix; and/or
a first weighted sum of the at least one first conditional statistic moment and the at least one second conditional statistic moment.

Example A4. The UE 22 of any one of Examples A1-A3, wherein the reference dataset corresponds to at least a portion of a radio measurement dataset which was used to train the first ML model for location inference.

Example A5. The UE 22 of any one of Examples A1-A4, wherein the operational dataset corresponds to a real-time radio measurement dataset provided to the first ML model during a deployment of the first ML model for location inference.

Example A6. The UE 22 of any one of Examples A1-A5, wherein the UE 22 is further configured to:
receive and/or store the plurality of ML models.

Example A7. A UE 22 configured to communicate with a network node 16, the UE 22 configured to, and/or comprising a radio interface and/or processing circuitry configured to:
switch, tune or deactivate a model based on a model drift indication.

Example A8. The UE 22 of Example A7, wherein the UE 22 is further configured to:
receive the model drift indication; or
determine the model drift indication.

Example A9. The UE 22 of Example A8, wherein the drift indication is an indication of statistical distance between first and second datasets of the model.

Example B1. A method implemented in a UE 22 configured to communicate with a network node 16, the method comprising:
determining a first model monitoring metric for a first ML model of a plurality of ML models, the first model monitoring metric being based on a statistical distance between a reference dataset and an operational dataset; and
optionally, one of:
   switching to a second ML model of the plurality of ML models based on the first model monitoring metric exceeding a threshold drift value; and
   tuning at least one parameter of the first ML model based on the first model monitoring metric exceeding the threshold drift value.

Example B2. The method of Example B1, wherein the first model monitoring metric for the first ML model is determined by:
determining a first statistical knowledge matrix for the reference dataset and a second statistical knowledge matrix for the operational dataset; and
comparing the first statistical knowledge matrix with the second statistical knowledge matrix.

Example B3. The method of any one of Examples B1 and B2, wherein the first statistical knowledge matrix is determined based on one or more of:
at least one first conditional statistic moment of the first knowledge matrix;
at least one second conditional statistic moment of the second knowledge matrix; and/or
a first weighted sum of the at least one first conditional statistic moment and the at least one second conditional statistic moment.

Example B4. The method of any one of Examples B1-B3, wherein the reference dataset corresponds to at least a portion of a radio measurement dataset which was used to train the first ML model for location inference.

Example B5. The method of any one of Examples B1-B4, wherein the operational dataset corresponds to a real-time radio measurement dataset provided to the first ML model during a deployment of the first ML model for location inference.

Example B6. The method of any one of Examples B1-B5, wherein the method further comprises:
receiving and/or storing the plurality of ML models.

Example B7. A method implemented in a UE 22 configured to communicate with a network node 16, the method comprising:
switching, tuning or deactivating a model based on a model drift indication.

Example B8. The method of Example B7, wherein the method further comprises:
receiving the model drift indication; or
determining the model drift indication.

Example B9. The method of Example B8, wherein the drift indication is an indication of statistical distance between first and second datasets of the model.

Example C1. A network node 16 configured to communicate with a UE, the network node 16 configured to, and/or comprising a radio interface and/or processing circuitry configured to:
determine a first model monitoring metric for a first ML model of a plurality of ML models, the first model monitoring metric being based on a statistical distance between a reference dataset and an operational dataset; and
optionally, one of:
   switch to a second ML model of the plurality of ML models based on the first model monitoring metric exceeding a threshold drift value; and
   tune at least one parameter of the first ML model based on the first model monitoring metric exceeding the threshold drift value.

Example C2. The network node 16 of Example C1, wherein the first model monitoring metric for the first ML model is determined by:
determining a first statistical knowledge matrix for the reference dataset and a second statistical knowledge matrix for the operational dataset; and
comparing the first statistical knowledge matrix with the second statistical knowledge matrix.

Example C3. The network node 16 of any one of Examples C1 and C2, wherein the first statistical knowledge matrix is determined based on one or more of:
at least one first conditional statistic moment of the first knowledge matrix;
at least one second conditional statistic moment of the second knowledge matrix; and/or
a first weighted sum of the at least one first conditional statistic moment and the at least one second conditional statistic moment.

Example C4. The network node 16 of any one of Examples C1-C3, wherein the reference dataset corresponds to at least a portion of a radio measurement dataset which was used to train the first ML model for location inference.

Example C5. The network node 16 of any one of Examples C1-C4, wherein the operational dataset corresponds to a real-time radio measurement dataset provided to the first ML model during a deployment of the first ML model for location inference.

Example C6. The network node 16 of any one of Examples C1-C5, wherein the network node 16 is further configured to:
receive and/or store the plurality of ML models.

Example C7. A network node 16 configured to communicate with a UE, the network node 16 configured to, and/or comprising a radio interface and/or processing circuitry configured to:
switch, tune or deactivate a model based on a model drift indication.

Example C8. The network node 16 of Example C7, wherein the network node 16 is further configured to:
receive the model drift indication; or
determine the model drift indication.

Example C9. The network node 16 of Example C8, wherein the drift indication is an indication of statistical distance between first and second datasets of the model.

Example D1. A method implemented in a network node 16 configured to communicate with a UE, the method comprising:
determining a first model monitoring metric for a first ML model of a plurality of ML models, the first model monitoring metric being based on a statistical distance between a reference dataset and an operational dataset; and
optionally, one of:
   switching to a second ML model of the plurality of ML models based on the first model monitoring metric exceeding a threshold drift value; and
   tuning at least one parameter of the first ML model based on the first model monitoring metric exceeding the threshold drift value.

Example D2. The method of Example D1, wherein the first model monitoring metric for the first ML model is determined by:
determining a first statistical knowledge matrix for the reference dataset and a second statistical knowledge matrix for the operational dataset; and
comparing the first statistical knowledge matrix with the second statistical knowledge matrix.

Example D3. The method of any one of Examples D1 and D2, wherein the first statistical knowledge matrix is determined based on one or more of:
at least one first conditional statistic moment of the first knowledge matrix;
at least one second conditional statistic moment of the second knowledge matrix; and/or
a first weighted sum of the at least one first conditional statistic moment and the at least one second conditional statistic moment.

Example D4. The method of any one of Examples D1-D3, wherein the reference dataset corresponds to at least a portion of a radio measurement dataset which was used to train the first ML model for location inference.

Example D5. The method of any one of Examples D1-D4, wherein the operational dataset corresponds to a real-time radio measurement dataset provided to the first ML model during a deployment of the first ML model for location inference.

Example D6. The method of any one of Examples D1-D5, wherein the method further comprises:
receiving and/or storing the plurality of ML models.

Example D7. A method implemented in a network node 16 configured to communicate with a UE, the method comprising:
switching, tuning or deactivating a model based on a model drift indication.

Example D8. The method of Example D7, wherein the method further comprises:
receiving the model drift indication; or
determining the model drift indication.

Example D9. The method of Example D8, wherein the drift indication is an indication of statistical distance between first and second datasets of the model.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
AI Artificial Intelligence
BS Base Station
CE Channel Estimate
MAC Medium Access Control
ML Machine Learning
PBCH Physical Broadcast Channel
PSS Primary Synchronization Signal
RRC Radio Resource Control
RF Radio Frequency
SSS Secondary Synchronization Signal
TRP transmission reception point
TRX Transceiver
UE User Equipment

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method performed by a user equipment, UE, configured to communicate with a network node, the method comprising:
determining a first model monitoring metric for a first machine learning, ML, model, the first model monitoring metric being based on a statistical distance between a reference dataset and an operational dataset; and
performing at least one action based on the first model monitoring metric.

2. The method of claim 1, wherein the reference dataset corresponds to at least a portion of a radio measurement dataset that was used to train the first ML model.

3. The method of claim 1, wherein the operational dataset corresponds to a real-time radio measurement dataset provided to the first ML model during a deployment of the first ML model.

4. The method of claim 1, wherein, based on the first model monitoring metric exceeding a threshold, performing the at least one action comprises causing transmission of an indication that model drift has occurred.

5. The method of claim 1, further comprising at least one of switching, tuning or deactivating a model based on a model drift indication.

6. The method of claim 1, further comprising one of:
receiving a model drift indication; or
determining the model drift indication.

7. The method of claim 6, wherein the model drift indication comprises an indication that the statistical distance:
is greater than a first threshold and less than or equal to a second threshold, the second threshold being greater than the first threshold; or
is greater than the second threshold.

8. The method of claim 7, wherein the at least one action comprises one of:
a warning signal, based on the statistical distance being greater than the first threshold and less than or equal to the second threshold; or
an alarm signal, based on the statistical distance being greater than the second threshold.

9. A user equipment, UE, configured to communicate with a network node, the UE comprising processing circuitry configured to:
determine a first model monitoring metric for a first machine learning, ML, model, the first model monitoring metric being based on a statistical distance between a reference dataset and an operational dataset; and
perform at least one action based on the first model monitoring metric.

10.-16. (canceled)

17. A network node configured to communicate with a user equipment, UE, the network node comprising processing circuitry configured to:
determine a first model monitoring metric for a first machine learning, ML, model, the first model monitoring metric being based on a statistical distance between a reference dataset and an operational dataset; and
perform at least one action based on the first model monitoring metric.

18. The network node of claim 17, wherein the reference dataset corresponds to at least a portion of a radio measurement dataset that was used to train the first ML model.

19. The network node of claim 17, wherein the operational dataset corresponds to a real-time radio measurement dataset provided to the first ML model during a deployment of the first ML model.

20. The network node of claim 17, wherein, based on the first model monitoring metric exceeding a threshold, performing the at least one action comprises causing transmission of an indication that model drift has occurred.

21. The network node of claim 17, wherein the processing circuitry is further configured to at least one of switch, tune or deactivate a model based on a model drift indication.

22. The network node of claim 17, wherein the processing circuitry is further configured to one of:
receive a model drift indication; or
determine the model drift indication.

23. The network node of claim 22, wherein the model drift indication comprises an indication that the statistical distance:
is greater than a first threshold and less than or equal to a second threshold, the second threshold being greater than the first threshold; or
is greater than the second threshold.

24. The network node of claim 23, wherein the at least one action comprises one of:
a warning signal, based on the statistical distance being greater than the first threshold and less than or equal to the second threshold; or
an alarm signal, based on the statistical distance being greater than the second threshold.

25. A method performed by a network node configured to communicate with a user equipment, UE, the method comprising:
determining a first model monitoring metric for a first machine learning, ML, model, the first model monitoring metric being based on a statistical distance between a reference dataset and an operational dataset; and
performing at least one action based on the first model monitoring metric.

26.-32. (canceled)

33. The method of claim 2, wherein the operational dataset corresponds to a real-time radio measurement dataset provided to the first ML model during a deployment of the first ML model.

34. The method of claim 2, wherein, based on the first model monitoring metric exceeding a threshold, performing the at least one action comprises causing transmission of an indication that model drift has occurred.
